(19) United States
(12) Patent Application Publication
(10) Pub. No.: US 2010/0078081 A1
(43) Pub. Date: Apr. 1, 2010

(54) TEMPERATURE CONTROL VALVE

(76) Inventor: Joseph R. McKee, Ventura, CA (US)

Correspondence Address: F. CHAU & ASSOCIATES, LLC, 130 WOODBURY ROAD, WOODBURY, NY, 11797, US

(21) Appl. No.: 12/241,561

(22) Filed: Sep. 30, 2008

(51) Int. Cl. F16K 31/64; F16K 31/12

(52) U.S. Cl. 137/468; 137/485

(57) ABSTRACT

A valve comprises a valve body including an inlet through which fluid flows into the valve, a main valve including a main poppet positioned in the valve body and including a chamber therein, wherein the fluid flows into the chamber, a pilot valve including a pilot poppet positioned within the main valve and including a discharge port through which the fluid flows out of the chamber, a main poppet spring biased to force the main poppet closed in the absence of flow of the fluid into the valve, a pilot poppet spring biased to keep the discharge port open, and a plurality of bi-metal disks located within the chamber. The plurality of bi-metal disks curl at a predetermined temperature of the fluid to compress the pilot poppet spring and close the discharge port. As a result, the fluid is prevented from flowing out of the chamber and fluid pressure between the chamber and the inlet is equalized to close the main poppet.

### BACKGROUND OF THE INVENTION

1. Technical Field

The present disclosure relates to a temperature control valve, and more specifically, to a temperature control valve that shuts off fluid flow at a specific temperature.

2. Discussion of the Related Art

Within the industrial and transportation fields, there exists a need to shut off fluid flow, for example, from a pump or from a venting system, if the fluid temperature becomes too hot. Such a controlling function is necessary in order to prevent damage to components, including those generating or receiving the fluid flow. The fluid in such cases may be, for example, oil or steam.

An example of a device or system where fluid flow must be controlled is the gear case venting lines in large aircraft engines. Under most conditions, it is desirable to have a circulation of compressor bypass air through the case to prevent condensation, remove generated heat, and maintain proper gear geometry by maintaining a relatively constant gear case temperature. Should circulating air become too hot, such as if an internal seal starts to have excessive leakage, discharge from higher pressure compressor stages and even combustor heat can be drawn into the flow. Excessive heat can destroy the lubricant protecting the gears and generate coking. This flow must be shut off before such excessive temperature enters the gear case.

Accordingly, there is a need for a temperature control valve that shuts off fluid flow at a specific temperature, regardless of altitude, operating pressure, or pressure drop.

### SUMMARY OF THE INVENTION

Embodiments of the present invention provide a pilot operated temperature control valve that employs bi-metal disks to throttle flow through a control port to open and close the valve, based on temperature.

A valve, in accordance with an embodiment of the present invention, comprises a valve body including an inlet through which fluid flows into the valve, a main valve including a main poppet positioned in the valve body and including a chamber therein, wherein the fluid flows into the chamber, a pilot valve including a pilot poppet positioned within the main valve and including a discharge port through which the fluid flows out of the chamber, a main poppet spring biased to force the main poppet closed in the absence of flow of the fluid into the valve, a pilot poppet spring biased to keep the discharge port open, and a plurality of bi-metal disks located within the chamber. The plurality of bi-metal disks curl at a predetermined temperature of the fluid to compress the pilot poppet spring and close the discharge port. As a result, the fluid is prevented from flowing out of the chamber and fluid pressure between the chamber and the inlet is equalized to close the main poppet.

The valve may further comprise a disk seat attached to the pilot poppet and positioned at an end of the bi-metal disks, wherein an increase in an end-to-end length of the bi-metal disks exerts a force on the disk seat, and a force on the pilot poppet spring. The disk seat may enclose a plurality of connector pins connecting the pilot poppet to the disk seat. There may be at least eight bi-metal disks, and a diameter of the main poppet may be larger than a diameter of the inlet.

The valve may further comprise a groove formed in the pilot poppet, a pin positioned in the groove, a cam ring holding the pin in the groove, and a detent spring exerting a force on the cam ring, wherein the pin holds the pilot poppet to keep the discharge port open until a force from the bi-metal disks overcomes the force of the detent spring.

A method for closing a valve based on a temperature change of fluid flowing through the valve, in accordance with an embodiment of the present invention, comprises biasing a main poppet closed with a main poppet spring in the absence of flow of the fluid into the valve, flowing the fluid into the valve through an inlet, and into a chamber positioned in the main poppet, flowing the fluid out of the chamber through a pilot valve discharge port, biasing the discharge port open with a pilot poppet spring, curling a plurality of bi-metal disks located within the chamber at a predetermined temperature of the fluid to compress the pilot poppet spring and close the discharge port to prevent the fluid from flowing out of the chamber, and equalizing fluid pressure between the chamber and the inlet to close the main poppet.

The method may further comprise attaching a disk seat to the pilot poppet and positioning the disk seat at an end of the bi-metal disks, and increasing an end-to-end length of the bi-metal disks to exert a force on the disk seat, and a force on the pilot poppet spring.

The method may further comprise positioning a pin in a groove formed in the pilot poppet, holding the pin in the groove, wherein the pin is held in the groove by a cam ring, and exerting a force on the cam ring, wherein the pin holds the pilot poppet to keep the discharge port open until a force from the bi-metal disks overcomes the exerted force on the cam ring. A detent spring can be used to exert the force on the cam ring.

### BRIEF DESCRIPTION OF THE DRAWINGS

Exemplary embodiments of the present invention will be described below in more detail, with reference to the accompanying drawings, of which:

FIG. 1 is a perspective view of a temperature control valve, according to an embodiment of the present invention;

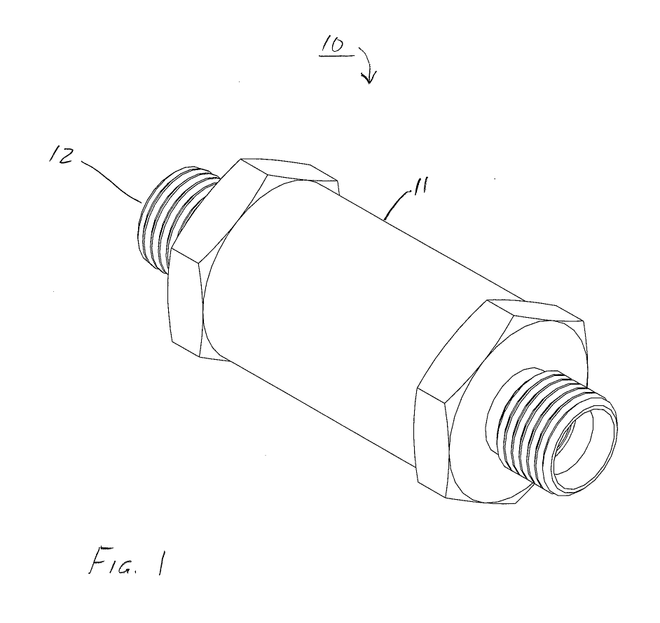

FIG. 2 is a front view of a temperature control valve, according to an embodiment of the present invention;

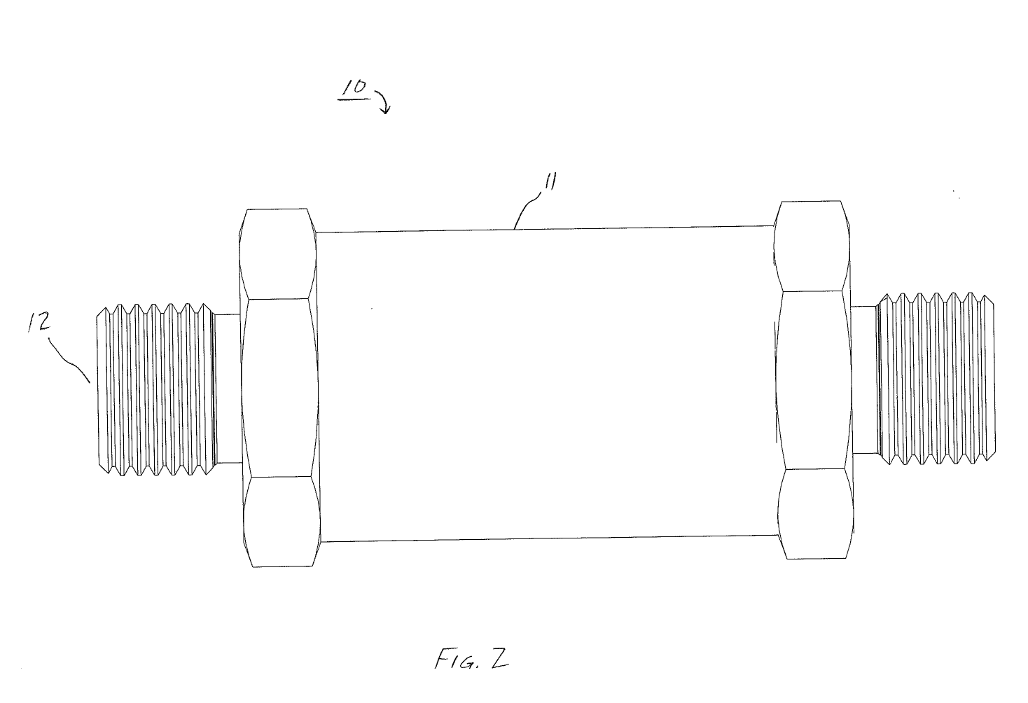

FIG. 3 is a left side view of a temperature control valve, according to an embodiment of the present invention;

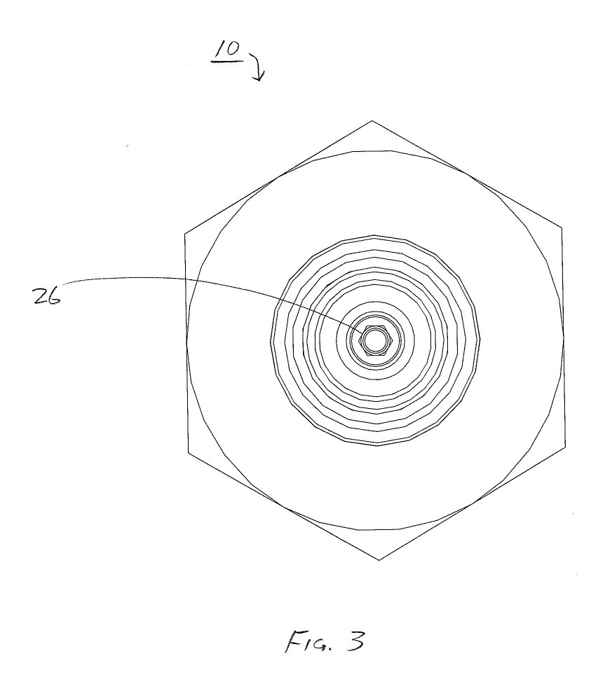

FIG. 4 is a right side view of a temperature control valve, according to an embodiment of the present invention;

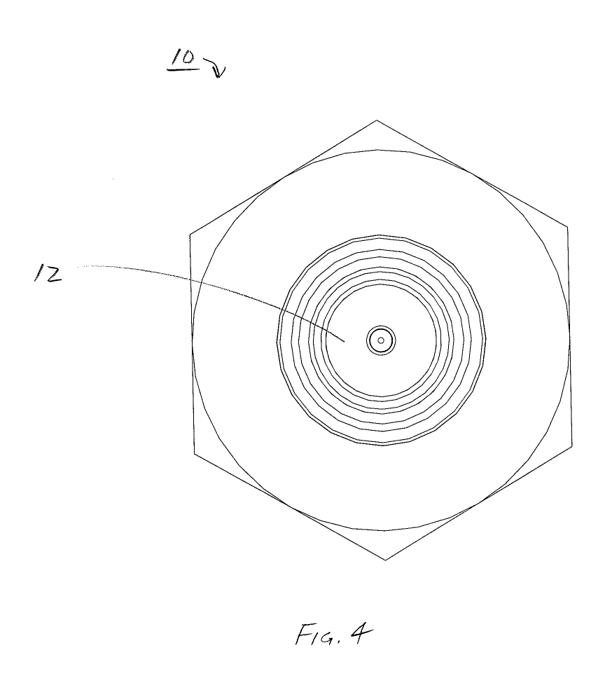

FIG. 5 is a sectional view of a temperature control valve when fluid temperature is below a set point, according to an embodiment of the present invention;

FIG. 6 is a perspective sectional view of a temperature control valve when fluid temperature is below a set point, according to an embodiment of the present invention;

FIG. 7 is a sectional view of a temperature control valve when fluid temperature is above a set point, according to an embodiment of the present invention;

FIG. 8 is a perspective sectional view of a temperature control valve when fluid temperature is above a set point, according to an embodiment of the present invention;

FIG. 9 is a sectional view of a temperature control valve including a detent mechanism, according to an embodiment of the present invention; and

FIG. 10 is a perspective sectional view of a temperature control valve including a detent mechanism, according to an embodiment of the present invention.

### DETAILED DESCRIPTION OF EXEMPLARY EMBODIMENTS

Exemplary embodiments of the present invention now will be described more fully hereinafter with reference to the accompanying drawings. This invention may, however, be embodied in many different forms and should not be construed as limited to the embodiments set forth herein.

Referring to the figures, a temperature control valve 10 includes a main valve body 11 housing a main poppet 13. Fluid, for example, oil or gas, enters the valve body 11 through valve inlet 12.

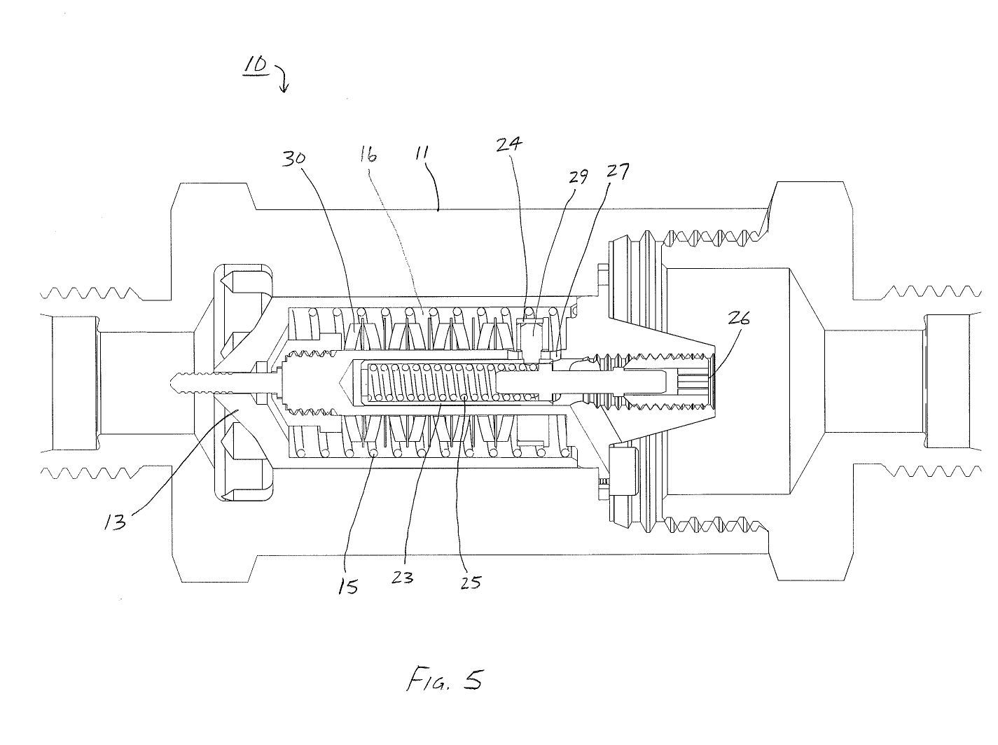

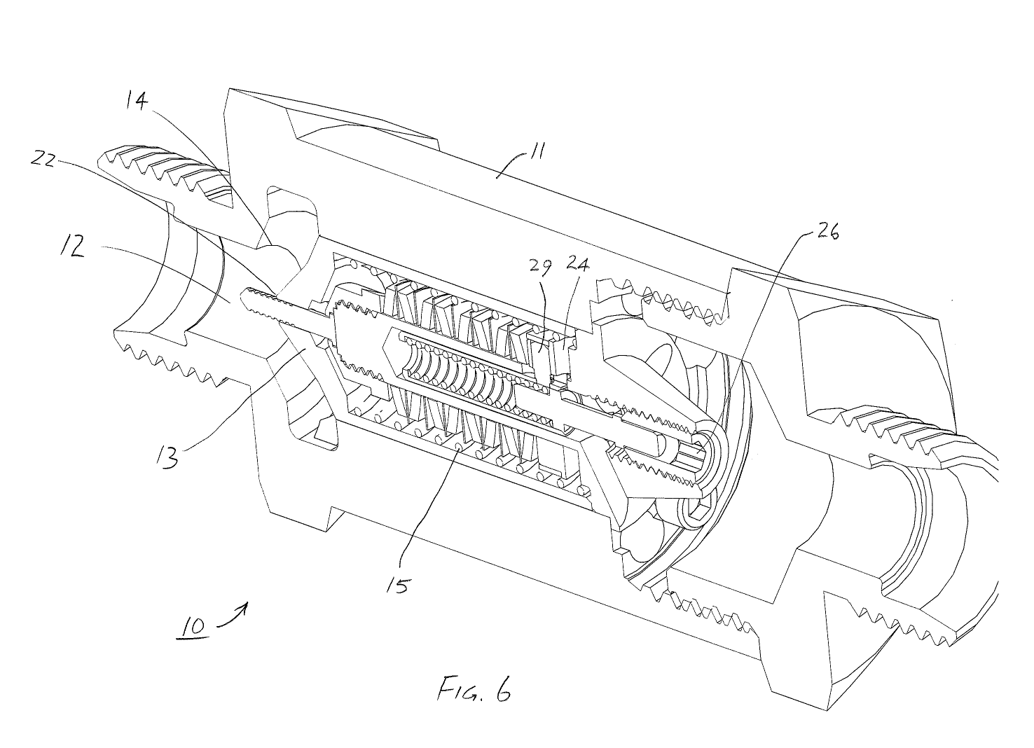

FIGS. 5 and 6 show the operation of the valve 10 when the fluid temperature is below an allowed/set point. The valve 10 employs a main poppet 13 that is larger in diameter than the main valve seat 14. The seat diameter is the same as the diameter of the inlet port 12. A light spring 15 holds the main poppet 13 against the seat 14 in the absence of inlet flow. A small portion of the incoming fluid is leaked into a chamber 16 in the interior of the main poppet 13. This chamber will be referred to as the control chamber 16. Pressure in the control chamber 16 acts on the full diameter of the main poppet 13.

A pilot valve is positioned within the main valve and includes a pilot poppet/valve sleeve 23. Fluid enters the pilot valve through a pilot valve inlet orifice 22. As shown in FIGS. 5 and 6, when the pilot valve is open, the pilot poppet spring 25 keeps the pilot poppet/valve sleeve 23 positioned to the left in FIG. 5, thereby keeping the pilot valve port 27 open. As a result, fluid from the control chamber 16 may vent through the pilot valve port 27 to discharge conduit 28.

When fluid is discharged from the control chamber 16 through the open pilot valve, fluid pressure within the control chamber 16 remains less than fluid pressure at the valve inlet 12. As long as the fluid pressure on the inside of the main poppet 13 is enough lower than the incoming fluid pressure from inlet 12, the valve will allow incoming fluid to overcome the main poppet spring 15 and force the main poppet 13 open, compressing the main poppet spring 15, which then allows fluid to flow through the valve. Accordingly, the main poppet 13 is maintained in the open position.

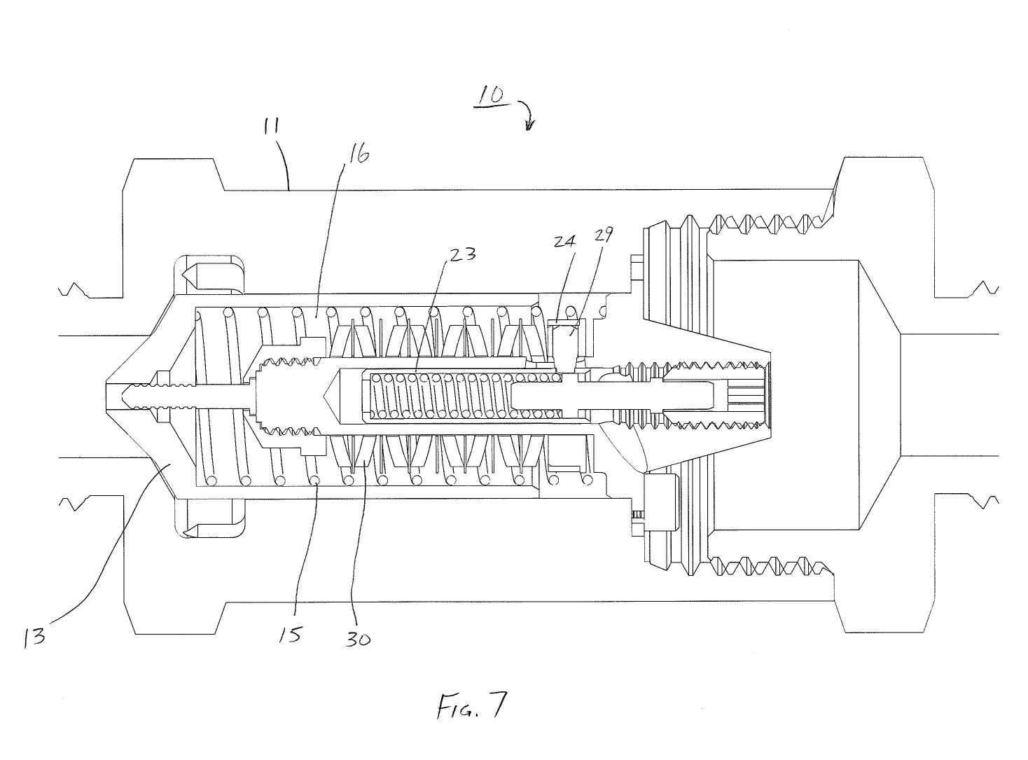

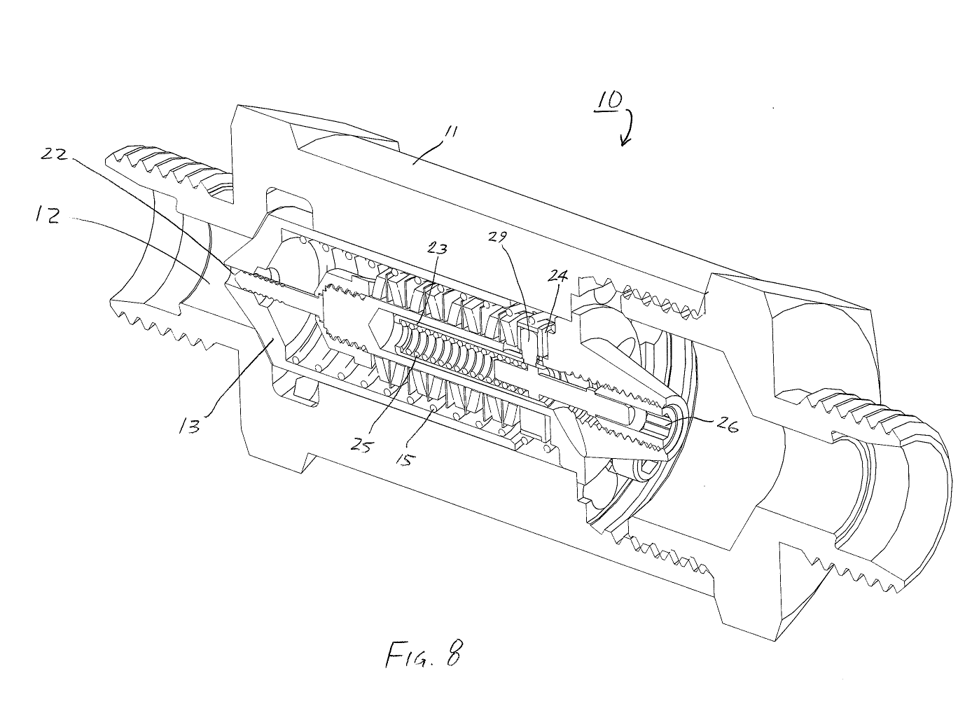

Referring to FIGS. 7 and 8, when the fluid temperature rises to above an allowed/set point, a curl of bi-metal disks 30 increases so that the end-to-end length of the plurality of bi-metal disks 30 increases. For example, the end-to-end length of the bi-metal disks 30 when the fluid temperature is below a set point may be about 0.060 inches, and, when the fluid temperature is above a set point, the end-to-end length of the bi-metal disks 30 may be about 0.064 inches. The increase in the end-to-end length of the bi-metal disks 30 drives a disk seat 24 to the right in FIG. 7 to compress pilot poppet spring 25. As a result, the pilot valve port 27 is closed, so that fluid from the control chamber 16 no longer vents through port 27 to valve discharge 28.

When fluid no longer drains from the control chamber 16, since the piston area of the controlling portion of the main poppet 13 is larger than that of the seat 14, the fluid pressure in the control chamber 16 increases to the fluid pressure at the inlet 12, so that poppet 13 moves to the left in FIG. 7 to close the main valve and prevent further fluid flow.

Accordingly, as long as the fluid leaked into the control chamber 16 passes through and drains into the valve discharge 28, the main poppet 13 will be pushed open, compressing the poppet spring 15, and allowing flow through the valve. If the draining of the control chamber 16 is blocked, pressure in the control chamber 16 will increase to inlet pressure. Since the control chamber pressure works against the full poppet diameter, and that diameter is larger than the inlet port 12, the main poppet 13 closes, shutting off flow.

Bi-metal refers to an object that is composed of two separate metals joined together. Instead of being a mixture of two or more metals, like alloys, bimetallic objects consist of layers of different metals. Bi-metallic strips and disks convert a temperature change into mechanical displacement. According to an embodiment of the present invention, the layers include, but are not limited to, for example, iron-nickel-chrome alloy against Invar or copper against stainless steel, and are responsive to temperature ranges including, for example, −200° F. to +600° F. The number of bi-metal disks 30 may be, for example, eight (8), to over 40.

Referring to FIGS. 5-6, when the temperature is below the set temperature of the valve, the pilot poppet/sleeve spring 25 keeps the pilot poppet/sleeve to the left, lightly compressing, via a plurality of (e.g., 3) connector pins 29 and the disk seat 24, a stack of partially curled bimetallic disks 30. This allows control chamber fluid to drain, keeping the pressure in that chamber 16 close to the (lower) pressure on the discharge side of the valve. The disk seat 24 surrounds the plurality of connector pins 29, which are attached to the pilot valve sleeve/poppet 23 to connect the pilot valve sleeve/poppet 23 to the disk seat 24.

Referring to FIGS. 7 and 8, as the fluid temperature increases to above an allowed/set point, the bi-metal disks curl more to increase their end-to-end length. As a result, the pilot poppet/sleeve 23 is forced to move to the right in FIG. 7 via the disk seat 24 and the three connector pins 29. This compresses the pilot sleeve spring 25 and closes the pilot valve port 27. This shuts off the flow draining the control chamber 16. As a result, control chamber pressure raises to that of the inlet port 12. Since the piston area of the control chamber portion of the main poppet 13 is larger than the main poppet seat 14, force from control chamber pressure and the main poppet spring 15 closes the main poppet 13 and prevents fluid flow.

The pilot valve includes a pilot valve adjuster 26 which can be turned with, for example, a hexagonal shaped wrench, to adjust the compression force of the pilot poppet spring 25. As a result, the required temperature to compress the spring 25 and close the pilot port 27 can be made higher or lower.

According to an embodiment of the present invention, once the fluid temperature cools and returns to below an allowed/set point, the curl of the bi-metal disks 30 decreases, thereby decreasing the end-to-end length of the disks 30 so that the pilot poppet/sleeve spring 25 is no longer compressed. As a result, the spring 25 is once again able to push the pilot poppet/sleeve 23 to the left, lightly compressing, via the plurality of (e.g., 3) connector pins 29 and the disk seat 24, the stack of partially curled bimetallic disks 30. As a result, the pilot valve port 27 is opened and the fluid in the control chamber 16 is again allowed to drain, thereby keeping the pressure in that chamber 16 close to the lower pressure on the discharge side of the valve so that the main poppet 13 can open.

According to alternative embodiments, the action of the pilot valve can be restrained so as not to allow the valve to respond to a change in temperature until a specific temperature different from that causing a response by the bi-metal disks alone is reached. At which point, the valve can snap to the open or closed position. For example, one or more detents having the same or different designs can be used to keep the valve open or closed after the valve has responded to a temperature change. For example, such restraints may be required for safety to avoid a situation where a brief temperature excursion occurs, causing damage the valve system, and then the valve resets itself without any record of the event. With one type of detent or latch design, the valve needs to be manually reset so as not miss any potential damage to the system.

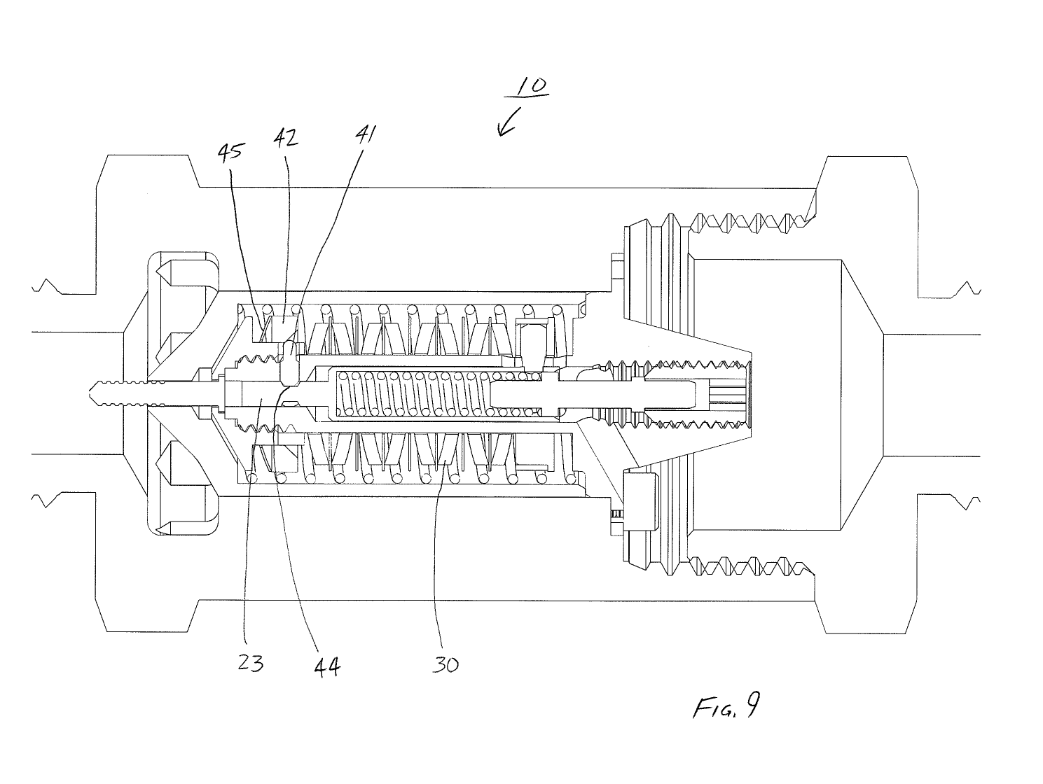

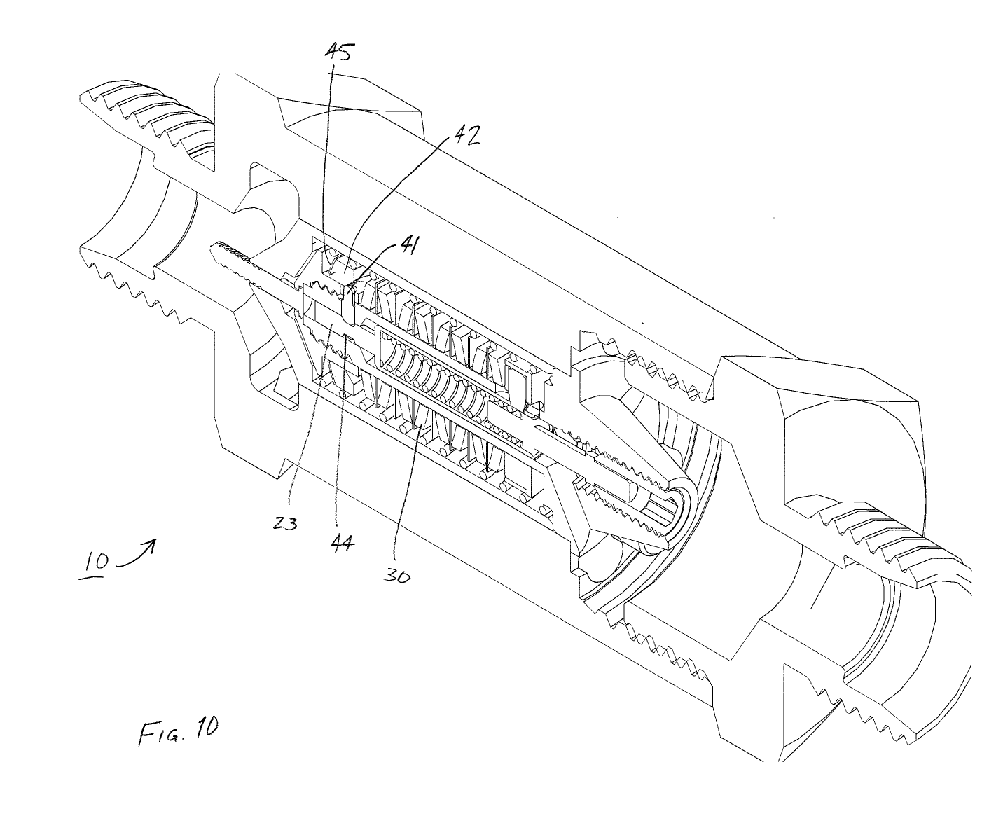

Referring to FIGS. 9 and 10, a detent pin 41 engages a groove 44 formed in the pilot valve poppet 23, holding the poppet/sleeve 23 back to keep the pilot valve port 27 open until force from the bi-metal disks 30 overcomes the restraining force of the detent spring 45. The detent spring 45 may be formed as a curved disk, which pushes on cam ring 42, thereby holding the detent pin 41 in the groove 44. There may be one or more detent pins 41. For example, according to an embodiment of the present invention, three (3) detent pins 41 are positioned in the groove 44. The detent pins 41, which are held in place by the cam ring 42, continue to hold the pilot valve open. The cam ring 42 holds the detent pins 41 in the groove 44 until force from the bi-metal disks 30 overcomes the force of spring 45.

Depending on factors, such as the strength of the spring 45, where and how the groove 44 is positioned on the poppet 23, the depth of the groove 44, and the angle of the groove's sides, the valve can be held open, closed or biased to open or close later than if operating with the bimetallic disks 30 working alone.

For example, the angle of the cam ring 42 and/or the shape/depth of the groove can be changed such that the force from the bi-metal disks 30 cannot be overcome. According to an embodiment, an outside collar can connect to the cam ring 42. As a result, the cam ring 42 can then be pulled back, compressing the detent spring 45 and allowing the detent pins 41 to be pushed out of the groove 44.

In an embodiment, a detent mechanism may be employed, for example, between the disk seat 24 and the pilot valve body, to keep the pilot port 27 closed until a specific lower temperature is reached, at which point, the pilot sleeve spring 25 will overcome the detent force and move the pilot poppet/sleeve 23 to the left to open the pilot port 27.

As an alternative to the detent mechanism, a mechanical latch may be employed to lock the pilot valve closed until it is manually or remotely (via, for example, a solenoid or piston) reset.

Although exemplary embodiments of the present invention have been described hereinabove, it should be understood that the present invention is not limited to these embodiments, but may be modified by those skilled in the art without departing from the spirit and scope of the present invention, as defined in the appended claims.

What is claimed is:

1. A valve, comprising:
a valve body including an inlet through which fluid flows into the valve;
a main valve including a main poppet positioned in the valve body and including a chamber therein, wherein the fluid flows into the chamber;
a pilot valve including a pilot poppet positioned within the main valve and including a discharge port through which the fluid flows out of the chamber;
a main poppet spring biased to force the main poppet closed in the absence of flow of the fluid into the valve;
a pilot poppet spring biased to keep the discharge port open; and
a plurality of bi-metal disks located within the chamber, wherein the plurality of bi-metal disks curl at a predetermined temperature of the fluid to compress the pilot poppet spring and close the discharge port, thereby preventing the fluid from flowing out of the chamber and equalizing fluid pressure between the chamber and the inlet to close the main poppet.

2. The valve according to claim 1, further comprising a disk seat attached to the pilot poppet and positioned at an end of the bi-metal disks, wherein an increase in an end-to-end length of the bi-metal disks exerts a force on the disk seat, and a force on the pilot poppet spring.

3. The valve according to claim 2, wherein the disk seat encloses a plurality of connector pins connecting the pilot poppet to the disk seat.

4. The valve according to claim 1, wherein the plurality of bi-metal disks include at least eight bi-metal disks.

5. The valve according to claim 1, wherein a diameter of the main poppet is larger than a diameter of the inlet.

6. The valve according to claim 1, further comprising:
a groove formed in the pilot poppet;
a pin positioned in the groove;
a cam ring holding the pin in the groove; and
a detent spring exerting a force on the cam ring, wherein the pin holds the pilot poppet to keep the discharge port open until a force from the bi-metal disks overcomes the force of the detent spring.

7. A method for closing a valve based on a temperature change of fluid flowing through the valve, comprising:
biasing a main poppet closed with a main poppet spring in the absence of flow of the fluid into the valve;
flowing the fluid into the valve through an inlet, and into a chamber positioned in the main poppet;
flowing the fluid out of the chamber through a pilot valve discharge port;
biasing the discharge port open with a pilot poppet spring;
curling a plurality of bi-metal disks located within the chamber at a predetermined temperature of the fluid to compress the pilot poppet spring and close the discharge port to prevent the fluid from flowing out of the chamber; and
equalizing fluid pressure between the chamber and the inlet to close the main poppet.

8. The method according to claim 7, further comprising:
attaching a disk seat to the pilot poppet and positioning the disk seat at an end of the bi-metal disks; and
increasing an end-to-end length of the bi-metal disks to exert a force on the disk seat, and a force on the pilot poppet spring.

9. The method according to claim 8, wherein the disk seat encloses a plurality of connector pins connecting the pilot poppet to the disk seat.

10. The method according to claim 7, wherein the plurality of bi-metal disks include at least eight bi-metal disks.

11. The method according to claim 7, wherein a diameter of the main poppet is larger than a diameter of the inlet.

12. The method according to claim 7, further comprising:
positioning a pin in a groove formed in the pilot poppet;
holding the pin in the groove, wherein the pin is held in the groove by a cam ring; and
exerting a force on the cam ring, wherein the pin holds the pilot poppet to keep the discharge port open until a force from the bi-metal disks overcomes the exerted force on the cam ring.

13. The method according to claim 12, wherein a detent spring exerts the force on the cam ring.
